(19) United States
(12) Patent Application Publication
(10) Pub. No.: US 2016/0289962 A1
(43) Pub. Date: Oct. 6, 2016

(54) EDGE LIT FLOOR COVERING

(71) Applicant: Freeman Capital Company, Las Vegas, NV (US)

(72) Inventors: Carl Edward Crow, Grand Prairie, TX (US); Jay Atherton, Southlake, TX (US)

(21) Appl. No.: 14/678,747

(22) Filed: Apr. 3, 2015

(51) Int. Cl. E04B 5/46; E04F 19/00; F21V 8/00; E04C 2/54

(52) U.S. Cl. CPC E04B 5/46; E04C 2/54; E04F 19/00; G02B 6/0073; G02B 6/0068; G02B 6/0055; G02B 6/0093; G02B 6/0065

(57) ABSTRACT

An apparatus for illuminating a floor covering includes a panel having a light reflecting portion, a light source located at a lateral edge of the panel, and a protective cover. The light source projects light through the lateral edge of the panel for reflection from the light reflecting portion through a top surface of the panel. The protective cover protects the light source from damage due to objects passing over the apparatus.

### TECHNICAL FIELD

The present invention relates generally to floor coverings, and, more particularly, to a floor covering having at least one lighting element for illuminating a portion of the floor covering.

### BACKGROUND

Floor coverings such as carpets and rugs provide decorative elements to a floor of a building. In recent years, advertisers have designed carpets and rugs that include pictures or logos to advertise to people who are using a building. For example, retail stores often have rugs containing the store's logo located at entryways to the store.

In some instances, advertisers have desired the ability to illuminate a floor covering. To produce an illuminated effect on the floor covering, a portion of the floor under the floor covering is excavated to provide a space for televisions or lights below the floor covering. These types of lighted floor displays are expensive to install and maintain, and are not feasible in all types of buildings, such as, for example, temporarily leased locations where the structure of the building cannot be altered. For example, lighted floor displays of this type are not feasible for use in trade shows and convention centers where the participants rent space in a building for a limited time. It would be beneficial to have a lighted flooring cover that is easy to install and is suitable for use in buildings which cannot be altered by the tenants or lessees.

### SUMMARY

In a first aspect, there is provided an apparatus for illuminating a floor covering that includes a panel having a light reflecting portion, a light source located at a lateral edge of the panel, a protective cover and a panel cover. The light source projects light through the lateral edge of the panel for reflection from the light reflecting portion through a top surface of the panel. The protective cover protects the light source from damage due to objects passing over the protective cover, and at least a portion of the light reflected by the light reflecting portion passes through the protective cover.

In some embodiments, the light reflecting portion includes printed ink on a lower surface of the panel.

In other embodiments, the printed ink on the lower surface of the panel includes a repeated pattern of printed ink.

In still other embodiments, the printed ink includes a plurality of layers of ink.

In yet other embodiments, the ink is white.

In another embodiment, the panel includes polished edges.

In some embodiments, the protective cover includes a ramp portion and a base portion with a recess. The light source and the panel are at least partially located within the recess.

In other embodiments, the ramp includes an angled surface that extends from a surface of a floor of a building to the panel cover.

In still other embodiments, the panel cover is positioned above the panel and includes a graphic positioned for illumination by light reflected light from the light reflecting portion.

In a second aspect, there is provided an apparatus for illuminating a floor covering that includes a base having a recess, a panel located within the recess and having a reflective portion, a light source located within the recess to transmit light through the panel, and a panel cover positioned above the panel for illumination by light that is reflected from the reflective portion. The light source and the panel are located between the base and the panel cover.

In some embodiments, the light source includes a plurality of LED lights.

In other embodiments, the light source is positioned on a vertical edge of the recess.

In yet other embodiments, the vertical edge of the recess circumscribes the panel.

In still other embodiments, the base is coupleable to a ramp having a sloped surface that extends from a floor of a building to the panel cover.

In another embodiment, the reflective portion includes a printed ink pattern.

In a third aspect, there is provided a method of manufacturing an apparatus for illuminating a floor covering that includes providing a panel that includes an at least partially transparent material, printing ink on a surface of the panel, providing a base having a recess, positioning a light source in the recess, wherein the recess is sized to receive the panel therein so that an edge of the panel is located adjacent to the light source, and providing a panel cover that includes an image to be illuminated by the light source.

In some embodiments, the method also includes polishing an edge of the panel.

In other embodiments, providing a base further includes providing a ramp having a sloped surface that extends from a floor of a building to the panel cover.

In still other embodiments, printing ink on the surface includes printing a plurality of spaced-apart dots on the surface.

In yet other embodiments, printing ink on the surface includes printing a repeated pattern of dots on the surface.

For a more complete understanding of the present invention, including additional features, objects and advantages thereof, reference is now made to the following detailed description taken in conjunction with the drawings, in which:

### BRIEF DESCRIPTION OF THE DRAWINGS

FIG. 1 is a plan view of an edge lit floor covering in accordance with this disclosure.

FIG. 2 is an exploded perspective view of the edge lit floor covering of FIG. 1.

FIG. 3 is a cross-section view of a portion of the edge lit floor covering of FIG. 1.

FIG. 4 is a perspective view of the edge lit floor covering of FIG. 1 in partial assembled configuration with a carpet.

FIG. 5A is a plan view of a panel having a first printed pattern thereon in accordance with this disclosure.

FIG. 5B is a plan view of a panel having a second printed pattern thereon in accordance with this disclosure.

FIG. 5C is a plan view of a panel having a third printed pattern thereon in accordance with this disclosure.

FIG. 6A is a cross-section view of a portion of a panel having a first printed surface in accordance with this disclosure.

FIG. 6B is a cross-sectional view of a portion of a panel having a first print surface and a second printed surface in accordance with this disclosure.

FIG. 7 is a cross-section view of a portion of another embodiment of an edge lit floor covering.

FIG. 8 is a schematic block diagram illustrating a method of manufacturing a floor covering in accordance with this disclosure.

### DETAILED DESCRIPTION

In the description which follows, like parts are marked throughout the specification and drawings with the same reference numerals. The drawings may not be to scale and certain features may be shown exaggerated in scale or in somewhat schematic form in the interest of clarity and conciseness.

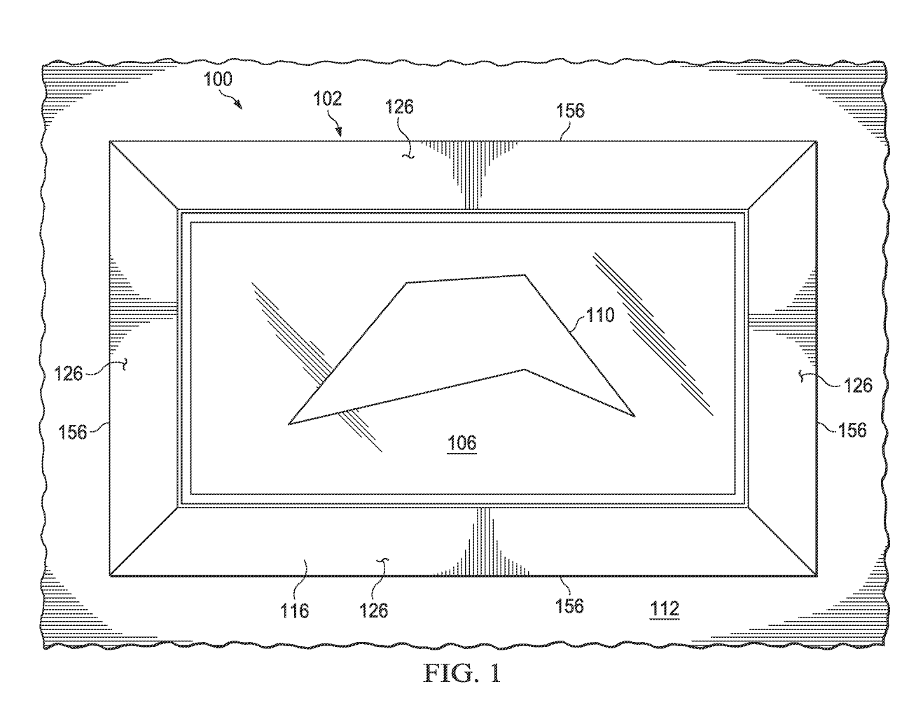

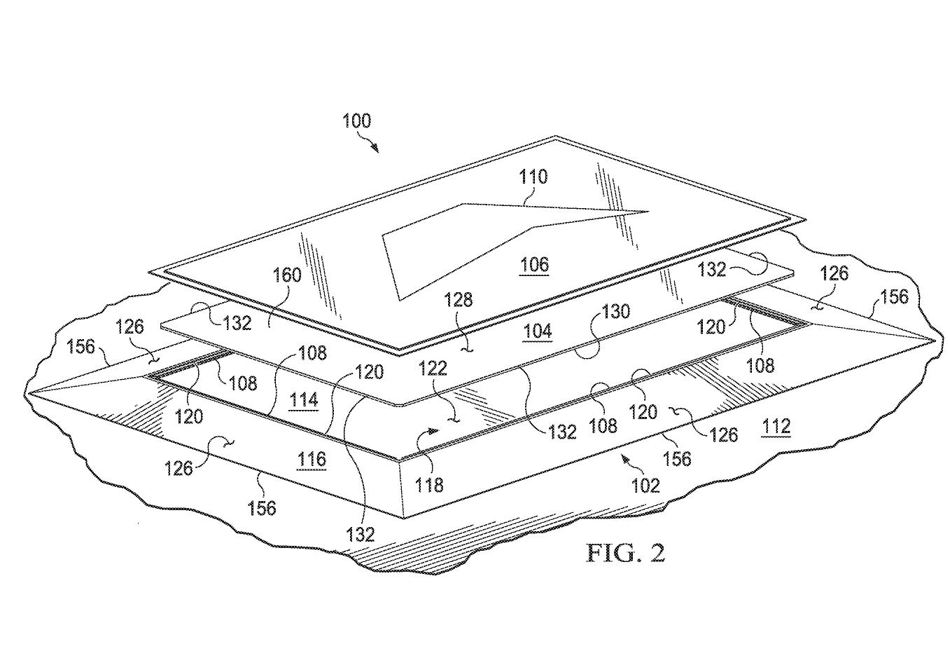

FIGS. 1-7 illustrate embodiments of an edge lit floor covering 100. Referring specifically to FIGS. 1 and 2, the edge lit floor covering 100 includes a protective cover 102 and a panel 104 (FIG. 2). As will be described in more detail below, the protective cover 102 includes a panel cover 106 to protect the panel 104, and a base portion 114 and a ramp portion 116 to protect a plurality of light sources 108 (FIG. 2) that illuminate the panel 104 and a panel cover 106. As will be discussed below, in some embodiments the panel cover 106 also protects the plurality of light sources 108. In some embodiments, the panel cover 106 includes a graphic 110 that is illuminated by light that passes through the panel 104 from the light sources 108. In use, a base portion 114 of the protective cover 102 is placed on a floor 112 of a building and the panel 104 and panel cover 106 are placed at least partially within a first recess 118 of the base portion 114, as described in more detail below. The light sources 108 project light into the panel 104 and the panel cover 106 to illuminate the panel cover 106. When fully assembled, the edge lit floor covering 100 provides an illuminated floor covering for a portion of a floor 112 without the need to excavate the floor 112. Thus, the edge lit floor covering 100 can be used in temporary or permanent locations. For example, the edge lit floor cover 100 is particularly useful in trade shows and convention centers which require portable, temporary floor coverings that are easily installed and maintained. The light sources 108 are protected from damage by the protective cover 102 so that objects can pass over the floor covering 100, such as work vehicles driven over the floor covering 100 or pedestrians walking over or standing on the floor covering 100. The edge lit floor covering 100 is reusable, easily transported between multiple locations, and easy to install.

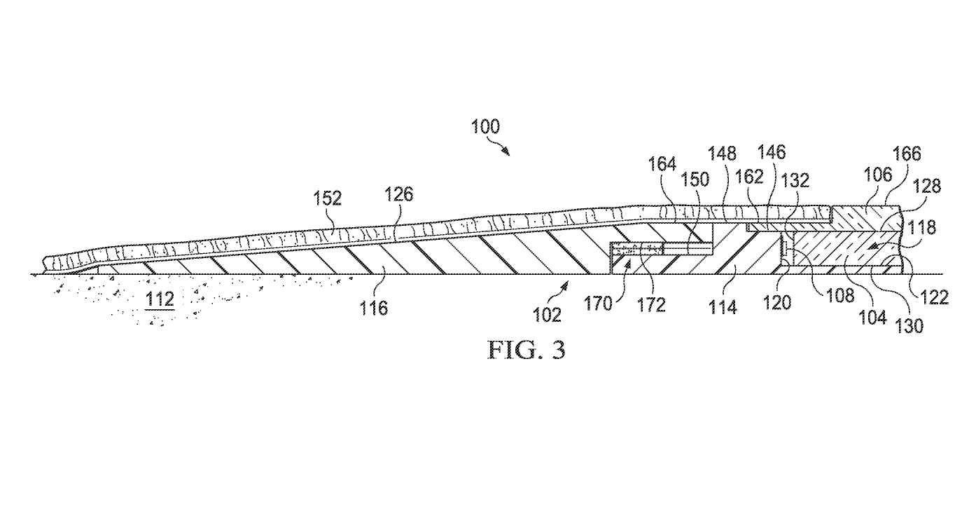

Referring again to FIGS. 1 and 2, the protective cover 102 includes a base portion 114, a ramp portion 116 that extends outwardly from the base portion 114, and a panel cover 106. Referring specifically to FIG. 2, in some embodiments the base portion 114 includes a first recess 118 that is sized and shaped to receive at least a portion of the panel 104 therein. The first recess 118 includes a recess wall 120 that circumscribes the panel 104 when the panel 104 is located in the first recess 118. The first recess 118 includes a flat bottom surface 122 that extends between the vertical recess walls 120. In some embodiments, the first recess 118 includes light sources 108 that are coupled to the vertical recess walls 120, as illustrated in FIGS. 2 and 3. When the panel 104 is positioned at least partially within the first recess 118, at least a portion of the panel side surfaces 132 are positioned adjacent to the light sources 108 on the vertical recess walls 120. Thus, at least some of the light from the light sources 108 enters the panel 104 through the side surfaces 132 when the edge lit floor covering 100 is in use.

In some embodiments, the base portion 114 includes a flat bottom surface (not shown) that contacts the floor 112 of a building when the apparatus 100 is in use. The base portion 114 may be any suitable size and shape. For example, in some embodiments the base portion 114 is rectangular and is approximately three feet by six feet. In another embodiment, the base portion 114 is between about one feet and about four feet in width and between about one feet and ten feet in length. The base portion may be between about ¾ inch and about three inches thick at the flat bottom surface 122 and between about ¼ and about three inches thick at the vertical walls 120. Thus, in some embodiments, the vertical recess walls 120 extend approximately one to two and ¼ inches above the flat bottom surface 112.

In some embodiments, the ramp portion 116 circumscribes the base portion 114 and includes a sloped surface 126. The sloped surface 126 provides a gradual transition between the floor 112 on which the edge lit floor covering 100 is placed and the panel cover 106. As such, objects that move over the edge lit floor covering 100 are gradually raised to a height of the panel cover 106 as they pass over the ramp portion 116. The ramp portion 116 may include several ramp pieces 156 (FIGS. 1 and 2) that are coupled together or a single unitary piece of material. In addition, the sloped surface 126 of the ramp portion 116 may have any suitable angle and may be linear or non-linear. The base portion 114 and the ramp portion 116 may have any suitable size and shape, such as, for example, a circular shape, an oblong shape, a square shape, or rectangular shape as shown in the embodiments of FIGS. 1 and 2. The ramp portion 116 may couple to the base portion 114 by any suitable coupling mechanism 170, such as a double-sided tape or Velco® connection. In other embodiments, the ramp portion 116 is integrally formed with the base portion 114.

The ramp portion 116 and the base portion 114 may be made of any suitable material. In some embodiments, for example, the ramp portion 116 and the base portion 114 are made of a polymer material. In yet other embodiments, the ramp portion 116 and the base portion 114 are made of a PVC material or a laminate material. In some embodiments, the ramp portion 116 is made of the same material as the base portion 114 while in other embodiments the ramp portion 116 is made of a different material than the base portion 114.

Referring specifically to FIG. 2, in some embodiments the panel 104 is a planar sheet of material having an upper surface 128, a lower surface 130 and side surfaces 132. In some embodiments, the panel 104 is made of a material that is at least partially translucent so that at least some light from the light sources 108 passes through the side surfaces 132 of the panel 104 and through at least a portion of a body 160 of the panel 104. In a preferred embodiment, for example, the panel 104 is made of a clear acrylic material. In other embodiments, the panel 104 is made of a clear polycarbonate material. In other embodiments, the panel 104 is made of any suitable material that is at least partially translucent.

The panel 104 may also have any suitable shape or size. In some embodiments, for example, the panel 104 is rectangular in shape and is sized to fit within the first recess 118 of the base portion 114. In some embodiments, the panel 104 is between about one and four feet wide and between about one and ten feet long. In other embodiments, the panel 104 may be any suitable size and shape that fits at least partially within the first recess 118 of the base portion 114. It has been found that the width of the panel 104 may be limited by the translucence of the material chosen for the panel 104. For example, in some embodiments it has been found that consistent lighting of the panel 104 dissipates at widths above about 3 feet. The maximum width of the panel 104 may depend on the type of lighting apparatus 108, the type of material chosen for the panel 104, whether the edges of the panel 104 are polished, and other factors. The panel 104 may be any suitable thickness and in some embodiments is between about ¼ inch and one inch thick.

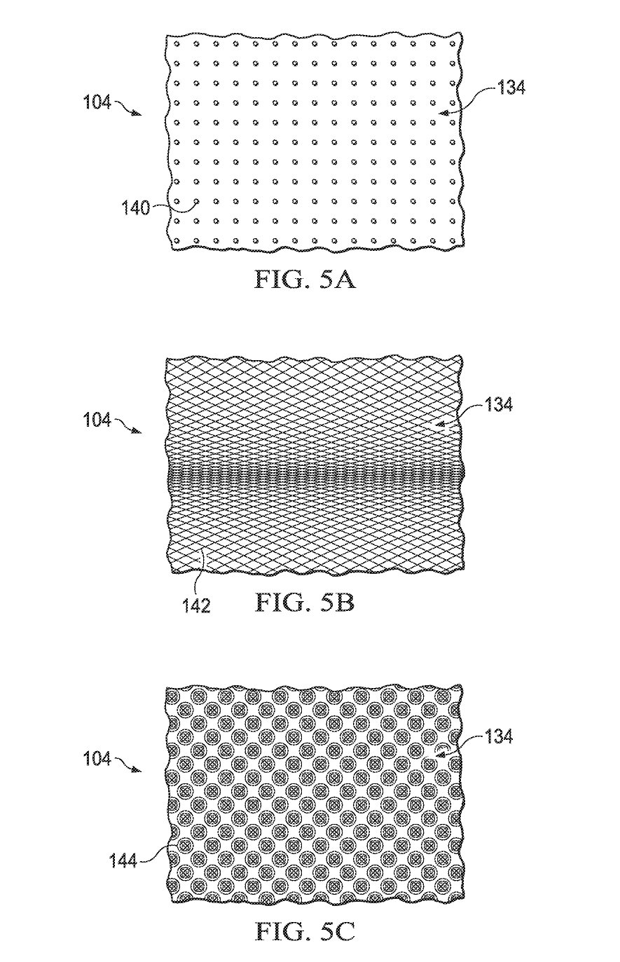

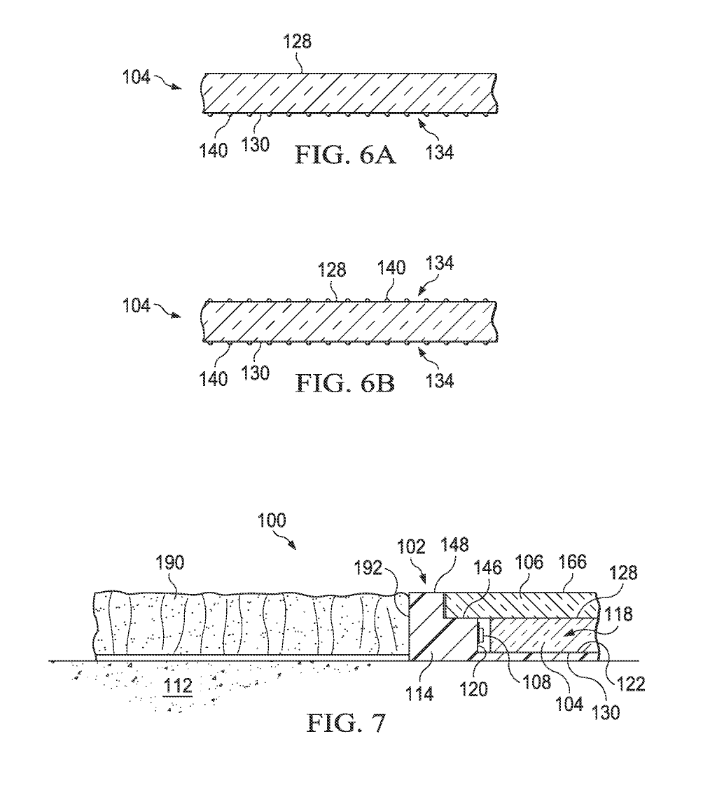

In some embodiments, the panel 104 includes a light reflecting portion 134 (FIGS. 5A, 5B, 5C, 6A and 6B) to reflect light that passes through the panel 104 from the light sources 108. In some embodiments, the light reflecting portion 134 is located at or near the lower surface 130 of the panel 104, as illustrated in FIG. 6A. In some embodiments, the light reflecting portion 134 is ink that has been printed or otherwise deposited on the lower surface 130 of the panel 104. In some embodiments, the printed ink forms a pattern that covers at least a portion of the lower surface 130 of the panel 104 and reflects light that is emitted from the light sources 108. In some embodiments, the percent of the area of the lower surface 130 on which ink has been printed varies according to the distance from the light sources 108. For example, in some embodiments the percent coverage increases as the distance from the light sources 108 increases. In some embodiments, the printed ink forms a pattern on the panel 104 that is repeated across the surface 128 or 130 of the panel 104. In some embodiments, it has been found that a repeated pattern of printed dots 140 on the panel 104 provides a more even light reflection than a variable pattern.

In some embodiments, the ink is white and the printed pattern includes a plurality of dots 140 (FIGS. 5A, 6A and 6B) that are spaced from each other and have a diameter that is less than about 0.0313 inch and a thickness that is less than about 0.0075 inches. In other embodiments, the dots 140 have a diameter between about 0.02 inches and about 0.04 inches and a thickness between about 0.007 inches and about 0.008 inches. It has been found that dots having a diameter of more than about 0.04 inches may cause dark spots to appear on the panel 104. In some embodiments, multiple layers of ink are deposited at each printed location on the panel 104. For example, in some embodiments the printed pattern is made using a double strike printing that deposits two layers of ink at each printed location. In some embodiments, the ink is printed onto the panel 104 by a flatbed ink jet printer.

The panel 104 may have any suitable pattern of printed ink on the lower surface 130, the upper surface 128 or the upper and lower surfaces 128 and 130 of the panel 104 in different embodiments. In the embodiment illustrated in FIG. 5A, for example, the printed ink pattern includes dots 140 of ink that are spaced from each other on the lower surface 130 of the panel 104. In the embodiment illustrated in FIG. 5B, the printed ink pattern includes intersecting printed lines 142 of ink. In the embodiment illustrated in FIG. 5C, the printed ink pattern includes a repeating circular shape 144. In other embodiments, the printed ink may have other patterns and shapes that may repeat or may not repeat. In some embodiments, the printed ink is white colored ink. In yet other embodiments, the ink may have any other color or the printed pattern may include multiple inks having different colors.

As discussed above, in some embodiments the printed ink is located only on the bottom surface 130 of the panel 104, as illustrated in the embodiment of FIG. 6A, while in other embodiments the printed ink is located on the top and bottom surfaces 128 and 130 of the panel 104, as illustrated in the embodiment of FIG. 6B.

In yet other embodiments, the light reflecting portion 134 may be any other suitable light reflecting member or members. For example, in some embodiments the light reflecting portion 134 is an etched pattern on the bottom surface 130 of the panel 104. In other embodiments, the light reflecting portion 134 is a reflective material that is coupled to or placed adjacent to the bottom surface 130 of the panel 104. As indicated above, the light reflecting portion 134 may be located at the upper surface 128, the lower surface 130, or both the upper and lower surfaces 128 and 130 of the panel 104.

Referring again to FIGS. 1 and 2, the panel cover 106 is positioned over the panel 104 and the light sources 108 when the edge lit floor covering 100 is in use. In some embodiments, the panel cover 106 protects the panel 104 from damage due to objects that pass over the apparatus 100, such as construction equipment and pedestrians. In some embodiments, the panel cover 106 is an at least partially planar sheet of material that includes a graphic 110 or other design that is illuminated by light that is reflected from the light reflecting portion 134 of the panel 104. In some embodiments, the panel cover 106 is slightly larger than the panel 104 so that the panel cover 106 extends past the outer perimeter of the panel 104 and contacts the base portion 114 or the ramp portion 116. In some embodiments, the outer perimeter of the panel cover 106 rest on a portion of the base portion 114 or the ramp portion 116 to protect the lighting elements, as will be described in more detail below. The panel cover 106 may be made of any suitable material that is at least partially translucent and may have any suitable size and shape. In some embodiments, for example, the panel cover 106 is rectangular in shape and is made of a clear polycarbonate material. In a preferred embodiment, the panel cover 106 is made of a clear, cast acrylic material. In yet other embodiments, the panel cover 106 is made of a clear, extruded acrylic material. In some embodiments, the panel cover 106 is between about ¼ inch and about 1 inch thick.

FIG. 3 illustrates a cross section view of a portion of the edge lit floor covering 100 of FIGS. 1 and 2. In the embodiment illustrated in FIG. 3, the base portion 114 includes a first recess 118, a second recess 146 located above the first recess 118, a top surface 148, and a coupling ledge 150. As illustrated in FIG. 3, the panel 104 rests in the first recess 118 when the edge lit floor covering 100 is in use so that the light sources 108 are located adjacent to the side surfaces 132 of the panel 104. In some embodiments, the side surfaces 132 of the panel 104 are polished to reduce the amount of light that is reflected by the side surface 132 before the light enters the panel 104.

In some embodiments, the light sources 108 are a plurality of LED lights that are attached to the vertical recess wall 120, as illustrated in FIG. 3. In some embodiments, the light sources 108 are LED lights having a wide light emitting angle. For example, in some embodiments the light sources 108 are LED lights having a 120 degree spread. In other embodiments, the light sources 108 may be any light emitting device, such as one or more incandescent bulbs or fluorescent bulbs. In some embodiments, the edge lit floor covering 100 includes a plurality of light sources 108 that are spaced along the length of each vertical recess wall 120 of the first recess 118. In the embodiment illustrated in FIG. 2, for example, the first recess 118 includes four recess walls 120 and each of the four recess walls 120 includes a plurality of LED light sources 108. In some embodiments, the light sources 108 are coupled to a power supply by a power cable (not shown) that extends through a portion of the protective cover 102.

In some embodiments, the light sources 108 are programmable to adjust the light strength, light emitting duration, light color or other attribute of the light sources 108. In some embodiments, for example, the light sources 108 engage when the power is lost in a building. In yet other embodiments, the light sources 108 engage when a person or object applies a force to the apparatus 100, such as by standing on the apparatus 100. In some embodiments, all of the light sources 108 are a uniform color while in other embodiments the light sources 108 are multiple colors.

Referring again to FIG. 3, the second recess 146 of the base portion 114 is positioned above the first recess 118 and supports an edge of the panel cover 106. When the panel cover 106 is supported on the second recess 146, the panel cover 106 extends over the light sources 108 to protect the light sources 108 from contact with objects that pass over the edge lit floor covering 100. In other embodiments, the light sources 108 may be further protected by being housed in a cutaway portion (not shown) of the recess wall 120 or by any other suitable means. The second recess 146 is sized and shaped to match the outer perimeter of the panel cover 106.

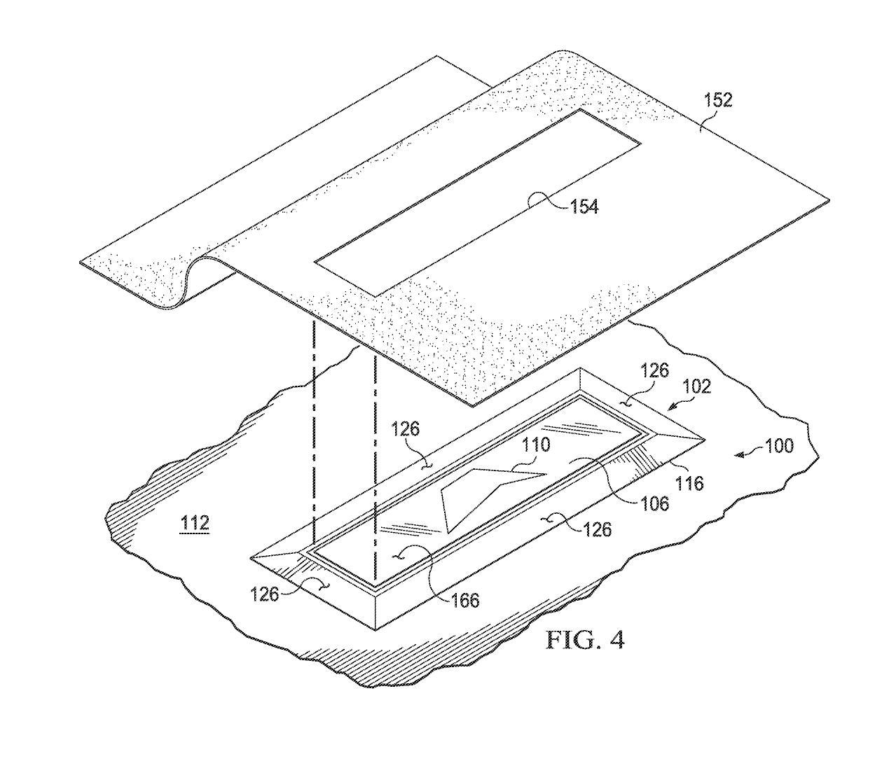

When the panel cover 106 is installed on the base portion 114, the top surface 148 of the base portion 114 is aligned with a panel cover recess 162 and a top surface 164 of the ramp portion 116. Thus, a carpet 152 can extend up the ramp portion 116 from the floor 112 to the panel cover recess 162 to form a smooth transition between the floor level and the top surface 166 of the panel cover 106, as illustrated in FIG. 3. For example, in some embodiments (see, e.g., FIG. 4), a user cuts an opening 154 in the carpet 152 that is sized and shaped to receive the top surface 166 of the panel cover 106 so that only the top surface 166 of the panel cover 106 is visible. Thus, the carpet 152 extends up the sloped surface 126 of the ramp portion 116 so that the top surface 166 of the panel cover 106 is at the level of the carpet 152. The top surface 166 may include a graphic 110 or logo that is illuminated by light that reflects from the reflective portion of the panel 104. In other embodiments, the top surface 166 does not include a graphic 110 or logo. In other embodiments, the panel cover 106 acts as a diffuser for light that passes through the panel 104.

Referring again to FIG. 3, in some embodiments the ramp portion 116 couples to the base portion 114 at coupling mechanism 170 located between the coupling ledge 150 of the base portion 114 and the coupling ledge 172 of the ramp portion 116. In some embodiments, the coupling mechanism 170 is a double sided tape or Velcro® connection. In other embodiments, the ramp portion 116 and the base portion 114 are integrally formed and thus do not require a coupling mechanism 170.

It has been found that the apparatus 100 can support the weight of one or more people walking on the apparatus 100, as well as the weight of equipment passing over the apparatus 100, such as a fork lift and other construction equipment. For example, in some embodiments the apparatus 100 can support between about 150 lbs. (e.g., the weight of an adolescent or adult) and about 9,000 lbs (e.g., the average weight of a small piece of construction equipment, such as a fork lift). In other embodiments, the apparatus 100 can support any weight up to about 9,000 lbs. In yet other embodiments, the apparatus 100 can support more than 9,000 lbs.

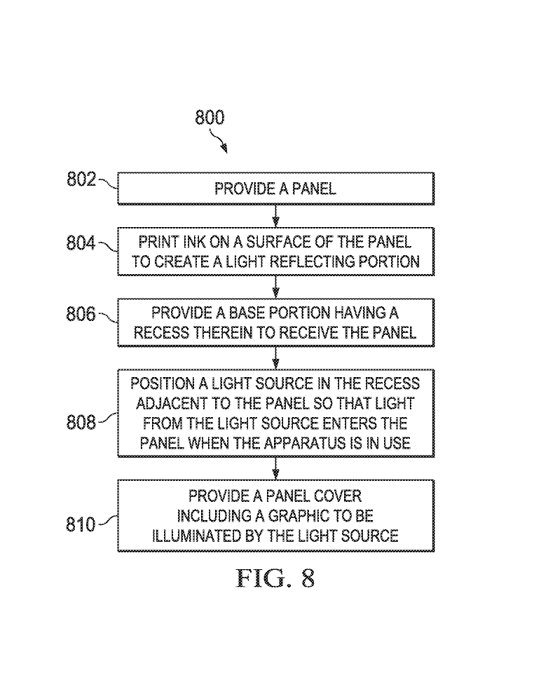

Referring now to FIG. 7, in some embodiments the protective cover 102 includes a base portion 114 but does not include a ramp portion 116. For example, in some embodiments a thick carpet 190 has a thickness that is approximately equal to a distance between the floor 112 and the top surface 148 of the base portion 114. As such, users can easily step from the carpet 190 to the apparatus 100 without the need for a ramp portion 116. In some embodiments, the ramp portion 116 is simply removed from the base portion 114 so that the carpet 190 directly abuts the base portion 114. In yet other embodiments, the base portion 114 does not include a coupling ledge 150 so that the carpet 190 directly abuts an outer wall 192 of the base portion, as illustrated in FIG. 7. In some embodiments, the top surface 148 of the base portion 114 is at a height that is approximately equal to the height of the carpet 190. In yet other embodiments, the top surface 148 of the base portion 114 is at a height that is approximately equal to the height of the carpet 190 and a padding or other material located below or on top of the carpet 190.

FIG. 8 illustrates an embodiment of a method 800 of manufacturing an edge lit floor covering 100. In some embodiments, the method 800 begins and a panel 104 is provided as illustrated at block 802. In some embodiments, the panel 104 is made of a material that is at least partially translucent. In some embodiments, ink is printed on a surface 128 or 130 of the panel 104 to create a light reflecting portion 134, as illustrated at block 804. In some embodiments, a base portion 114 is then provided having a recess 118 therein to receive the panel 104, as illustrated at block 806. In some embodiments, a light source 108 is positioned in the recess 118 adjacent to the panel 104 so that light from the light sources 108 enters the panel 104, as illustrated at block 808. As discussed above, the recess 118 may be sized to receive the panel 104 therein so that the side surfaces 132 of the panel 104 are adjacent to the light sources 108. In some embodiments, the method 800 also includes providing a panel cover 106 including a graphic 110 to be illuminated by the light source 108, as illustrated at block 810.

In some embodiments, the method 800 also includes polishing the side surfaces 132 of the panel 104 to reduce the amount of light that is reflected by the side surfaces 132 before reaching the light reflecting portion 134 of the panel 104. In some embodiments, the method 800 also includes printing a plurality of layers of ink on the panel 104 to form the light reflecting portion 134.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “outer” and “inner,” “upper” and “lower,” “first” and “second,” “internal” and “external,” “above” and “below” and the like are used as words of convenience to provide reference points and are not to be construed as limiting terms.

In addition, the foregoing describes only some embodiments of the invention(s), and alterations, modifications, additions and/or changes can be made thereto without departing from the scope and spirit of the disclosed embodiments, the embodiments being illustrative and not restrictive.

Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

Although specific embodiments have been described in detail, those skilled in the art will also recognize that various substitutions and modifications may be made without departing from the scope and spirit of the appended claims.

What is claimed is:

1. An apparatus comprising:
a panel having an upper surface, a lower surface, a thickness and at least one lateral edge, wherein the panel is at least partially translucent;
a light source located at the at least one lateral edge of the panel, wherein the light source projects light through the at least one lateral edge of the panel;
a light reflecting portion at the lower surface of the panel; and
a protective cover, wherein at least a portion of the protective cover is located above the light source.

2. The apparatus of claim 1, wherein the protective cover comprises a panel cover, a base portion and a ramp portion.

3. The apparatus of claim 2, wherein the base portion comprises a recess, wherein the light source and the panel are at least partially located within the recess.

4. The apparatus of claim 2, wherein the panel cover comprises a translucent material and wherein at least part of the panel cover is located above the light source.

5. The apparatus of claim 4, wherein at least a portion of light reflected from the light reflecting portion passes through the panel cover.

6. The apparatus of claim 1, wherein the light reflecting portion comprises printed ink on the lower surface of the panel.

7. The apparatus of claim 6, wherein the printed ink on the lower surface of the panel comprises a repeating pattern of printed ink.

8. The apparatus of claim 6, wherein the printed ink comprises a plurality of layers of ink.

9. The apparatus of claim 8, wherein the ink is white.

10. The apparatus of claim 1, wherein the panel comprises polished edges.

11. The apparatus of claim 2, wherein the ramp portion includes an angled surface that extends from a floor to the panel cover.

12. The apparatus of claim 2, wherein the panel cover is positioned above the panel and comprises a graphic positioned for illumination by light reflected light from the light reflecting portion.

13. The apparatus of claim 1, wherein the panel is at least partially translucent.

14. The apparatus of claim 2, wherein the panel cover is at least partially translucent.

15. The apparatus of claim 1, wherein the panel is made of a clear acrylic material.

16. The apparatus of claim 2, wherein the panel cover is made of a clear acrylic material.

17. The apparatus of claim 1, wherein the apparatus supports between about 150 lbs. and about 9,000 lbs.

18. The apparatus of claim 1, wherein the panel is between about 1 and about 3 feet wide and about 3 and about 10 feet long.

19. An apparatus for illuminating a floor covering, the apparatus comprising:
a base comprising a recess;
a panel located within the recess and having a reflective portion;
a light source located within the recess to transmit light through the panel; and
a panel cover positioned above the panel for illumination by light that is reflected from the reflective portion, wherein the light source and the panel are located between the base and the panel cover.

20. The apparatus of claim 19, wherein the light source comprises a plurality of LED lights.

21. The apparatus of claim 19, wherein the light source is positioned on a vertical edge of the recess.

22. The apparatus of claim 21, wherein the vertical edge of the recess circumscribes the panel.

23. The apparatus of claim 19, wherein the base includes a ramp having a sloped surface that extends from a floor to the panel cover.

24. The apparatus of claim 19, wherein the reflective portion comprises a printed ink pattern.

25. A method of manufacturing an apparatus for illuminating a floor covering, the method comprising:
providing a panel, wherein in the panel includes an at least partially transparent material;
printing ink on a surface of the panel;
providing a base having a recess;
positioning a light source in the recess, wherein the recess is sized to receive the panel therein so that an edge of the panel is located adjacent to the light source; and
providing a panel cover comprising an image to be illuminated by the light source.

26. The method of claim 25, further comprising polishing an edge of the panel.

27. The method of claim 25, wherein providing a base further comprises providing a ramp having a sloped surface that extends from a floor of a building to the panel cover.

28. The method of claim 25, wherein printing ink on the surface comprises printing a plurality of spaced-apart dots on the surface.

29. The method of claim 25, wherein printing ink on the surface comprises printing a repeating pattern of dots on the surface.
